(19) United States
(12) Patent Application Publication
(10) Pub. No.: US 2026/0155119 A1
(43) Pub. Date: Jun. 4, 2026

(54) WEIGHT BALANCING DEVICES, SYSTEMS, AND METHODS FOR PERCUSSION STANDS

(71) Applicant: DRUM WORKSHOP, INC., Oxnard, CA (US)

(72) Inventors: Ruben STEINHAUSER, Altusried (DE); Donald G. Lombardi, Westlake Village, CA (US)

(21) Appl. No.: 18/968,955

(22) Filed: Dec. 4, 2024

(51) Int. Cl. G10D 13/10

(52) U.S. Cl. CPC G10D 13/28

(57) ABSTRACT

Disclosed herein are devices, methods, and systems for balancing the weight of drum and percussion stands, and connection systems therefor. Some balancing devices according to the present disclosure include a connecting side and a receiving side. On the connecting side, the balancing devices are configured with a connector component that allows it to removably connect to a percussion stand or another balancing device. On the receiving side, the balancing devices are configured with a receiving portion that allows the devices to receive a connector component of another balancing device. The ability of the balancing devices to removably connect to one another allows for easy, incremental adjustments to the weight added to a percussion stand. Percussion stands according to the present disclosure can also include a receiving portion (e.g., in the bottom of the base tube), and/or can include other receiving mechanisms, such as receiving mechanisms in the stand legs.

### BACKGROUND

### 1. Field of the Disclosure

The present disclosure relates generally to devices, systems, and methods for balancing the weight of percussion stands, and in particular to devices configured to removably connect to the base and/or legs of percussion stands to ensure stability.

### 2. Description of the Related Art

Percussion stands carry and hold percussion instruments in place so that they can be conveniently played by a user. These instruments tend to be heavy, and the ideal placement of an instrument attached to the percussion stand does not always result in a balanced system, causing the stand to tip over or be imbalanced in weight. To resolve this issue many percussion instrument users simply adjust the stand's legs to try and compensate for the imbalance. Counterweights that attach to the top of the stand may be used but they are often ineffective or get in the way of use of the instrument or instruments attached to the percussion stand, and can also result in the system being top-heavy and prone to swaying or tipping over.

Accordingly, there is a present need for a novel and efficient device or system to balance a percussion stand for stability, which specifically deals with the aforementioned problems.

### SUMMARY OF THE DISCLOSURE

Disclosed herein are systems, methods, and devices for balancing a percussion stand, such as balancing devices that may be removably attached to percussion stands so as to balance the weight of the stand when it is holding percussive instruments.

One embodiment of a system for balancing a percussion stand according to the present disclosure includes a percussion stand with at least one balancing device. The balancing device comprises at least one of a connector component and a receiving portion, and the percussion stand comprises the other. The connector component is configured to removably connect to the receiving portion.

One embodiment of a balancing device for a percussion stand according to the present disclosure comprises a body with a connecting side and a receiving side. The connecting side comprises a connector component. The connector component is configured to removably connect to a percussion stand. The receiving side is also configured to receive an equivalent connector component.

One embodiment of a percussion stand according to the present disclosure comprises a base tube with a plurality of legs connected thereto. At least one of the base tube and the plurality of legs defines a receiving portion with an aperture and a plurality of slots, with the receiving portion configured to receive a balancing device.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 is a top, front, left-side perspective view of one embodiment of a balancing device according to the present disclosure;

FIG. 2 is a front view of the balancing device shown in FIG. 1;

FIG. 3A is a back view of the balancing device shown in FIG. 1;

FIG. 3B is a back perspective view of the balancing device shown in FIG. 1;

FIG. 4 is a left-side view of the balancing device shown in FIG. 1;

FIG. 5 is a right-side view of the balancing device shown in FIG. 1;

FIG. 6 is a top, front, left-side perspective view of two of the balancing devices shown in FIG. 1, connected to one another;

FIG. 7 is a perspective view of one embodiment of a percussion stand system according to the present disclosure; and

FIG. 8 is a perspective view of the percussion stand system of FIG. 7 with the legs of the percussion stand closed.

### DETAILED DESCRIPTION OF THE DISCLOSURE

Disclosed herein are devices, methods, and systems for balancing the weight of percussion stands. Some balancing devices (e.g., weights) according to the present disclosure include a connecting side and a receiving side. On the connecting side, the balancing devices are configured with a connector component that allows it to removably connect to a percussion stand or another balancing device. On the receiving side, the balancing devices are configured with a receiving portion that allows the devices to receive a connector component of another balancing device. This allows for easy, incremental adjustments to the weight added by the balancing device to a percussion stand. Percussion stands for use as part of the system can be configured with a receiving portion on the bottom thereof for connecting to one or more balancing devices, and can also include legs shaped for attachment to one or more of the balancing devices.

One embodiment of a system for balancing percussion stands includes a percussion stand and at least one balancing device. The balancing device is configured to removably connect to the percussion stand and/or to another balancing device. The percussion stand may include a base tube and a plurality of legs, and balancing devices disclosed herein can be configured to removably connect to the bottom of the base tube and/or to one or more of the legs of the stand.

In the following detailed description, numerous specific details are set forth in order to provide a more thorough understanding of embodiments incorporating features of the present disclosure. However, it will be apparent to one skilled in the art that devices, methods, and assemblies according to the present disclosure can be practiced without necessarily being limited to these specifically recited details.

Embodiments of the disclosure are described herein with reference to illustrations that are schematic illustrations of embodiments of the disclosure. As such, the actual size, components and features can be different, and variations from the shapes of the illustrations as a result, for example, of technological capabilities, manufacturing techniques and/or tolerances are expected. Embodiments of the disclosure should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the disclosure. In addition, components may be shown as one unit but may instead be a collection of components or units, or a collection of components or units may exist as one unit.

Throughout this description, the preferred embodiment and examples illustrated should be considered as exemplars, rather than as limitations on the present disclosure. As used herein, the term “disclosure,” “device,” “assembly,” “system” “method,” “present disclosure,” “present device” or “present method” refers to any one of the embodiments of the disclosure described herein, and any equivalents. Furthermore, reference to various feature(s) of the “disclosure,” “device,” “assembly,” “system,” “method,” “present disclosure,” “present device” or “present method” throughout this document does not mean that all claimed embodiments or methods must include the referenced feature(s).

It is also understood that when an element or feature is referred to as being “on” or “adjacent” another element or feature, it can be directly on or adjacent to the other element or feature, or intervening elements or features may also be present. It is also understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

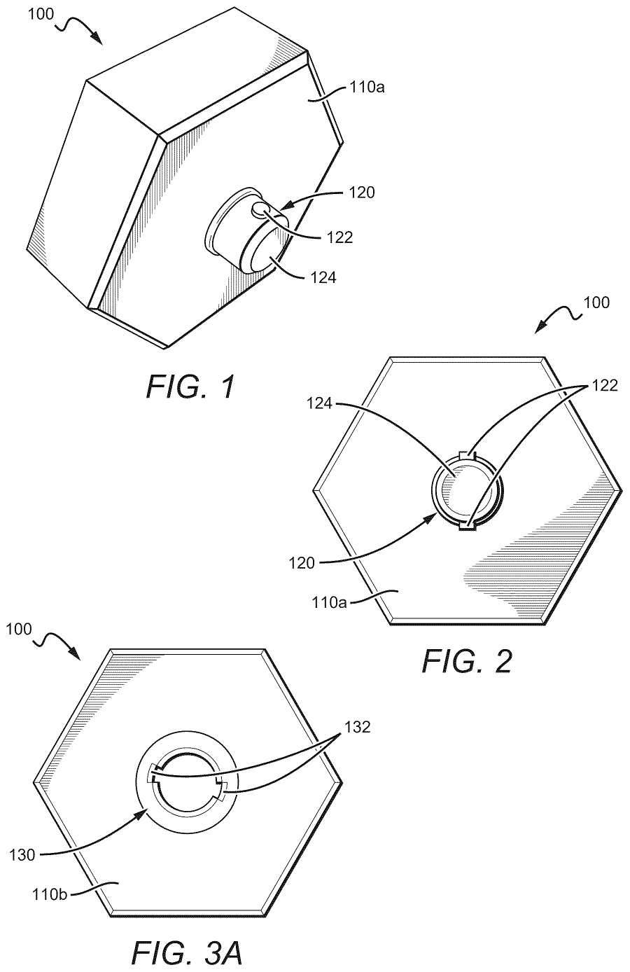

FIGS. 1-6 show one embodiment of a balancing device 100. The balancing device 100 has a connecting side 110a and a receiving side 110b. The connecting side 110a is configured with a connector component 120 and the receiving side is configured with a receiving portion 130. The connector component 120 and/or receiving portion 130 may be in the center of their respective sides, or may be in a different location; and/or they may be directly opposite one another on the balancing device 100.

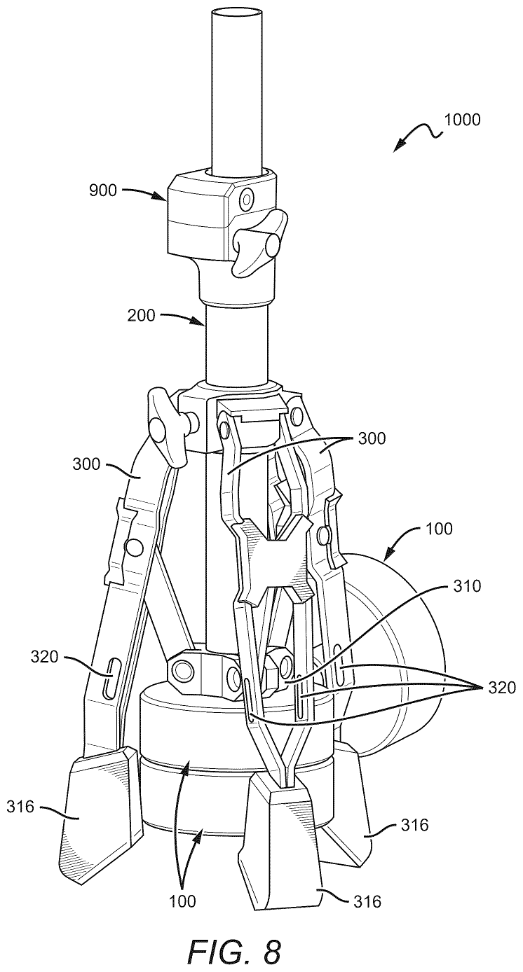

The connector component 120 allows the balancing device 100 to removably connect to a percussion stand, such as the percussion stand 900. FIGS. 7 and 8 show one embodiment of a percussion stand system 1000 according to the present disclosure. The system 1000 shown comprises a percussion stand 900 including a base tube 200, a plurality of legs 300, and one or more (in this case, three) balancing devices 100. The system may also include one or more instruments (not shown), such as one or more cymbals, toms, snares, and/or other instruments as would be understood by one of skill in the art.

The legs 300 of stands 900 according to the present disclosure can include one or more receiving portions 310 to which the connector component 120 of the balancing device 100 can removably connect. The connector component 120 of the balancing devices 100 shown in FIGS. 1, 2, and 4-8 is a peg 124 (e.g., a cylindrical, square, or other shaped peg) including one or more (in this case, two) protrusions 122. It should be understood that the peg and protrusions can be any shape as would be understood by one of skill in the art, and any number of protrusions could be included, with two or more protrusions being particularly advantageous.

Relatedly, the receiving portions 310 of the legs 300 shown in FIGS. 7 and 8 can be capable of receiving the connector component 120. In the embodiment shown, the receiving portion 310 of each of the legs 310 includes two branches 312 (e.g., opposing branches). The branches 312 can be substantially vertically oriented and/or can face one another, as shown. The branches 312 can be perpendicular to one another, or angled relative to one another, with the specific embodiment shown including branches 312 that move apart from one another as they move upward, though it is understood that the opposite is possible. The branches 312 can be symmetrical to one another about a central axis, though it is understood that other embodiments are possible. The branches 312 can terminate at a foot 316, and the branches 312 may rejoin one another before or at the foot 316, or may not rejoin each other before meeting the foot 316. The foot 316 may be made of, for example, rubber, or another material known in the art. Or the legs 310 may include one branch instead of two (i.e., single braced legs).

The branches 312 can each include a connection face 314, and the branches 312 and/or connection faces 314 can have heights (as shown by dimension “h” in FIG. 7) of 0.25″ to 3″, or 0.5″ to 2″, or greater than 0.25″, or greater than 0.5″, or 1″ or greater, or 3″ or less, or 2″ or less, though it is understood that these measurements are exemplary and many different heights are possible. The branches 312 and/or connection faces 314 can include one or more slots, with each branch 312 shown in the figures including one slot 320 each, though it should be understood that two or more slots are possible. The slots 320 may go through the entire width of the branch 312 (as shown in the figures), or may be an indentation in the connection face 314. The branches 312 and/or indentations can have many different widths, and in some embodiments have widths of 0.1″ to 1″, 0.1″ to 0.5″, 0.1″ to 0.25″, 0.1″ or greater, 0.25″ or greater, 0.5″ or greater, 1″ or less, 0.5″ or less, or other widths as would be understood by one of skill in the art. Smaller widths can help with connectability, while larger widths can help with sturdiness.

The diameter of the connector component 120, including the protrusions 122, can be larger than the distance (e.g., the minimum distance) between opposing slots 320; while the diameter of the connector component 120 excluding the protrusions 122 can be smaller than the distance (e.g., the minimum distance) between opposing slots 320. Thus, a user holding the balancing device 100 can place the connector component 120 between branches 312 such that the protrusions 322 are between the branches 312, and then rotate the balancing device 100 to fit the protrusions 122 into the slots 320. The slots 320 hold the connector component 120 in place via a friction fit.

In the embodiment shown in FIGS. 1-7, the balancing device 100 is hexagonal or circular with a diameter of approximately 4 inches (with diameter measurements in noncircular embodiments referring to the largest measurement across the face). It is understood that many different shapes for the balancing device 100 are possible, such as cylindrical, square, etc., and different diameters (e.g., between 1 and 12 inches, between 2 and 8 inches, 2 inches or larger, 12 inches or smaller, 8 inches or smaller, etc.) or width/length combinations are possible. The connector component 120 without protrusions 122 is cylindrical with a diameter of approximately 1 inch. With protrusions 122, the connector component 120 has a diameter of approximately 1.25″ (with the protrusions having a height of 0.125″ each). It is understood that different shapes for the connector component 120 are possible, and different diameters for the connector component 120 with protrusions 122 (e.g., 0.5 to 2 inches, with and/or without protrusions) are possible. The height and length of the slots 320 are approximately 0.1″ to 0.5″ (or approximately 0.3″) and 0.75″ to 1.75″ (or approximately 1.25″), respectively. The balancing device 100 can be attached at different areas along the slots'lengths. It is understood that the width and the length of the slots 320 relate to the size of the protrusions 122. All measurements herein, including those described above in this paragraph, are purely exemplary in nature, and it should be understood that measurements outside these ranges are possible.

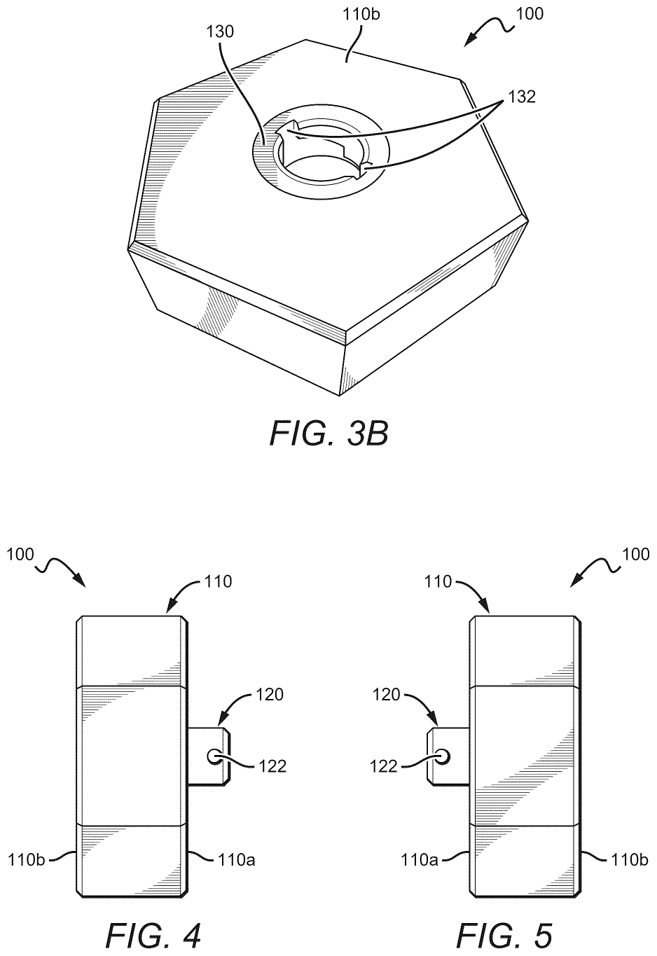

As noted above, the connector component 120 can also removably connect the balancing device 100 to a receiving portion 130. The receiving portion 130 may be included as part of a connector component 120, such as on the previously described receiving side 110b shown in FIGS. 3A and 3B, or may be included as part of another component, such as the bottom of the base tube 200 of the percussion stand 900 shown in FIGS. 7 and 8.

It should be understood that various different connections could be used, and that various different shapes, sizes, and styles of connector components 120 and receiving portions 130 can be used in embodiments of the current disclosure. In the specific embodiment shown, the receiving portion 130 is configured with two slots 132 (e.g., L-shaped slots as best seen in FIG. 3B), such that the connector component 120 and its two protrusions 122 can be inserted into the slots 132 and then rotated such that the connector component 120 and receiving portion 130 cannot be separated by simply pulling them apart axially and instead require rotation first, thus locking the connector component 120 and the balancing device 100. It should be understood that any number of slots 132 and protrusions 122 can be used, typically with a 1:1 ratio (though other embodiments are possible).

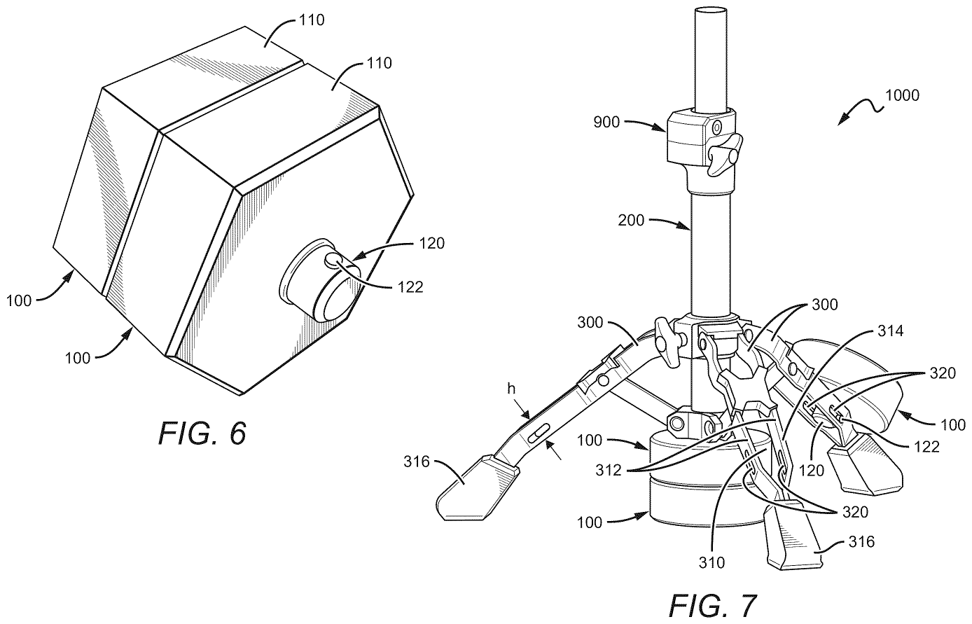

As shown in FIGS. 6-8, with the receiving portion 130 included as part of a second balancing device 100, two or more balancing devices can be connected to one another and then connected to another device such as the stand 900, thus providing additional weighting/balancing means if desired by the user.

A receiving portion 130 may also be used to attach to other devices, such as to the base tube 200 of the percussion stand 900 as shown in FIGS. 7 and 8. The receiving portion 130 may be an integral part of the bottom of the base tube 200, or alternatively may be an insert into the bottom of the base tube 200, which can be attached to the base tube 200 by, for example, a friction fit, adhesives, and/or other means known in the art. Similarly, the base tube could also include a connector component (e.g., male piece) while the device to be attached could include the receiving portion (e.g., female piece). Attachment of one or more balancing devices 100 in these manners can help to offset top-heaviness of a stand with an instrument, even if that stand/instrument system is approximately centrally balanced already. The receiving portion 130 may also be located elsewhere on the stand.

It should be understood that other than those devices and methods described herein, many other devices and methods for connecting the balancing device 100 to another such device 100 and/or to the percussion stand 900 are possible (e.g. snap connection, magnetic, friction fit, push button, male/female connection, threaded connection such as screws and threaded apertures, etc.), including both permanent and detachable devices and means, as would be understood by one of skill in the art.

The system shown in FIGS. 7 and 8 is shown utilizing three balancing devices 100, but it is understood that more or less can be used in systems according to the present disclosure. For example, 1, 2, 3, 4, 5, 6, or more balancing devices 100 may be used in systems according to the present disclosure. It is also understood that systems according to the present disclosure that include at least one balancing device removably connected to a percussion stand may be unbalanced but then become balanced once a percussion instrument is added to the percussion stand.

The ability of balancing devices 100 disclosed herein to removably attach to one another, and to various points on the percussion stand, allows for the weight added to balance a percussion stand to be quickly customizable and adjustable. This is especially important depending not only on the size and weight of the instrument the percussion stand is holding, but also at what height the instrument is placed on the stand, which may be adjusted depending on the musician.

In some embodiments, the balancing device 100 is solid. In some other embodiments of a balancing device 100, the body may be hollow and configured to be filled with material (e.g., with water, sand, rocks, metal balls, etc.), thereby allowing even further customization of weight being added to a percussion stand. The balancing device may comprise and/or be made of many different materials as would be understood by one of skill in the art, including but not limited to plastic, rubber, and/or metal. The protrusions may also be many different materials, with some exemplary materials being plastic, rubber, and/or metal, though many different materials are possible. Balancing devices 100 according to the present disclosure may have various weights, with exemplary weights being one pound or more, two pounds or more, three pounds or more, five pounds or more, or even greater; and/or 15 pounds or less, 10 pounds or less, 8 pounds or less, five pounds or less, three pounds or less, or even less. Many different embodiments are possible.

It should be understood that the connection systems, devices, and methods described herein could be applied to concepts other than weighting/balancing. For example, the same connection systems, devices, and methods can be used to attach a retracting height locking device such as those described in commonly owned U.S. patent application Ser. No. 18/920526 to Steinhauser et al., entitled “Height Locking Device for Percussion Stands,” which is fully incorporated by reference herein in its entirety. In another example, the connection systems/devices/methods could be used to attach a gas container (e.g., an air cylinder) for use in a pneumatic device, such as a pneumatic percussion stand, such as a modified version of the 9000 Series Airlift Snare Stand available from Drum Workshop, Inc., or to retrofit a traditional percussion stand. Other types of devices are also possible.

Typical drum or percussion stands are made primarily of metal, which is relatively heavy. The above-described systems, devices, and methods can be particularly useful when non-metal and/or alternative materials are used, such as plastic and/or carbon fiber, whether used as the primary stand material or just for components, such as when one or more legs 300 are made of or comprise the non-metal material (e.g., carbon fiber). The use of the lighter material can cause the stand to be more top-heavy, thus increasing the usefulness of the systems, devices, and methods described herein. Moreover, in particular, carbon fiber is known to be prone to failure when connectors such as screws are inserted into the carbon fiber; as such, the inclusion of apertures such as the slots 320 can be particularly advantageous in that devices can be attached without having to insert a connector into the carbon fiber itself.

It is understood that embodiments presented herein are meant to be exemplary. Although the present disclosure has been described in detail with reference to certain preferred configurations thereof both in the specification and in the claims, other versions are possible. Embodiments of the present disclosure can comprise any combination of compatible devices/features described herein and/or shown in the figures, and these embodiments should not be limited to those expressly illustrated and discussed. For instance and not by way of limitation, the appended claims could be modified to be multiple dependent claims so as to combine any combinable combination of elements within a claim set, or from differing claim sets. Claims depending on one independent claim could be modified so as to depend from a different independent claim. Therefore, the spirit and scope of the disclosure should not be limited to the versions described above.

While the foregoing written description of the disclosure enables one of ordinary skill to make and use what is considered presently to be the best mode thereof, those of ordinary skill will understand and appreciate the existence of variations, combinations, and equivalents of the specific embodiments, methods, systems, and examples herein. The disclosure should therefore not be limited by the above-described embodiments, methods, systems, and examples. Furthermore, certain terminology has been used for the purposes of descriptive clarity, and not to limit the present disclosure. It is therefore intended that the following appended claims include all such alterations, modifications and permutations as fall within the true spirit and scope of the present disclosure. No portion of the disclosure is intended, expressly or implicitly, to be dedicated to the public domain if not set forth in the claims.

We claim:

1. A system for balancing a percussion stand, the system comprising:
a percussion stand; and
at least one balancing device;
wherein said at least one balancing device comprises at least one of a connector component and a receiving portion, and said percussion stand comprises the other of said connector component and said receiving portion; and
wherein said connector component is configured to removably connect to said receiving portion.

2. The system for balancing a percussion stand of claim 1, wherein said at least one balancing device comprises said connector component, and said percussion stand comprises said receiving portion.

3. The system for balancing a percussion stand of claim 2, wherein said receiving portion is in a leg of said percussion stand.

4. The system for balancing a percussion stand of claim 3, wherein said connector component comprises a peg and two protrusions;
wherein said receiving portion comprises two branches each defining a slot, said receiving portion configured such that said connector component can be connected to said receiving portion by rotating said balancing device such that said protrusions are in said slots.

5. The system for balancing a percussion stand of claim 1, wherein said connector component is a threaded screw and said receiving portion is configured to receive said threaded screw.

6. The system for balancing a percussion stand of claim 1, wherein said receiving portion is in a base tube of said percussion stand.

7. The system for balancing a percussion stand of claim 6, wherein said connector component comprises a peg and two protrusions, and said receiving portion comprises an aperture and two slots, said two slots configured to receive said two protrusions.

8. The system for balancing a percussion stand of claim 7, wherein said receiving portion is an insert in a bottom of said base tube.

9. The system for balancing a percussion stand of claim 7, wherein said receiving portion is an integral part of said base tube.

10. The system for balancing a percussion stand of claim 1, wherein said at least one balancing device comprises said connector component, and said percussion stand comprises said receiving portion;
wherein said percussion stand comprises a plurality of legs attached to a base tube, and comprises a plurality of said receiving portions;
wherein a first of said receiving portions is in said base tube; and
wherein a second of said receiving portions is in one of said plurality of legs.

11. The system for balancing a percussion stand of claim 10, wherein said connector component comprises a peg and two protrusions;
wherein said first receiving portion comprises an aperture and two slots, said two slots configured to receive said two protrusions; and
wherein said second receiving portion comprises two branches of one of said legs, each of said branches defining a branch slot, each of said branch slots configured to receive one of said protrusions.

12. The system for balancing a percussion stand of claim 10, comprising two of said balancing devices, wherein a first of said balancing devices is removably connected to said first receiving portion, and a second of said balancing devices is removably connected to said second receiving portion.

13. A balancing device comprising a body with a connecting side and a receiving side, wherein said connecting side comprises a connector component configured to removably connect to a percussion stand, and said receiving side comprises a receiving portion configured to receive a second connector component equivalent to said connector component.

14. The balancing device of claim 13, wherein said connector component comprises a peg and two protrusions from said peg, and said receiving portion comprises an aperture and two slots, said aperture configured to receive said peg and said two slots configured to receive said two protrusions.

15. The balancing device of claim 14, wherein said slots are substantially L-shaped.

16. The balancing device of claim 13, wherein said balancing device weighs at least one pound.

17. The balancing device of claim 13, wherein said connector component and said receiving portion are directly opposite one another.

18. A percussion stand comprising:
a base tube; and
a plurality of legs attached to said base tube;
wherein at least one of said base tube and said plurality of legs defines a receiving portion comprising an aperture and a plurality of slots, said receiving portion configured to receive a balancing device.

19. The percussion stand of claim 18, wherein said receiving portion comprises two branches of one of said legs, each of said branches defining a branch slot.

20. A percussion stand comprising:
a base tube; and
a plurality of legs attached to said base tube;
wherein a bottom of said base tube defines a receiving portion configured to receive a balancing device.

21. The percussion stand of claim 20, further comprising said balancing device, wherein said balancing device comprises a connector component configured to connect to said receiving portion of said bottom of said base tube.

22. The percussion stand of claim 21, wherein said connector component magnetically connects to said receiving portion of said bottom of said base tube.

23. The percussion stand of claim 21, wherein said connector component is a threaded screw and said receiving portion is configured to receive said threaded screw.

24. The percussion stand of claim 21, wherein said connector component is configured to connect to said receiving portion via a friction fit.

25. The percussion stand of claim 21, wherein said connector component comprises of a peg and two protrusions, and said receiving portion comprises an aperture and two slots, said two slots configured to receive said two protrusions.
